(19) United States
(12) Patent Application Publication
(10) Pub. No.: US 2016/0167498 A1
(43) Pub. Date: Jun. 16, 2016

(54) Vehicle Cover

(71) Applicants: Maria A. Castillo, Upland, CA (US); Thomas Casillas, JR., Midwest City, OK (US)

(72) Inventors: Maria A. Castillo, Upland, CA (US); Thomas Casillas, JR., Midwest City, OK (US)

(21) Appl. No.: 14/966,004

(22) Filed: Dec. 11, 2015

Related U.S. Application Data
(60) Provisional application No. 62/091,931, filed on Dec. 15, 2014.

(51) Int. Cl. B60J 11/04; B60J 11/06

(52) U.S. Cl. CPC B60J 11/04; B60J 11/06

(57) ABSTRACT

A vehicle cover for use in preventing snow, ice, and other precipitation or debris from accumulating on the windshield or windows of a vehicle. The vehicle cover also helps to prevent the interior of the car from heating during periods of warm weather. The vehicle cover includes an elongated panel composed of a flexible and waterproof material. One or more flaps extend outward from the lower surface of the elongated panel, wherein the flaps are adapted to be positioned within the vehicle and secured in position by closing a door of a vehicle onto the flap or flaps. The elongated panel further includes one or more fasteners, such as magnetic fasteners, for securing the vehicle cover to the exterior of a vehicle. In some embodiments, the elongated panel includes one or more pockets in which the side view mirrors of the vehicle can be positioned.

### CROSS REFERENCE TO RELATED APPLICATION

This application claims the benefit of U.S. Provisional Application No. 62/091,931 filed on Dec. 15, 2014. The above identified patent application is herein incorporated by reference in its entirety to provide continuity of disclosure.

### BACKGROUND OF THE INVENTION

1. Field of the Invention

The present invention relates to vehicle covers. More specifically, the present invention provides a vehicle cover for preventing snow, ice and other debris from accumulating on the windshields or windows of a vehicle. The vehicle cover includes an elongated panel adapted to be positioned on the exterior of a vehicle, wherein the elongated panel includes one or more flaps that can be positioned into the interior of a vehicle by opening a door of the vehicle, and closing said door once the flap is positioned within the vehicle.

Snow, ice, and other precipitation commonly accumulate on the windshields and windows of vehicles. Similarly, other debris such as pollen, leaves, or animal waste, can also accumulate on a vehicle. As a result, the owner of the vehicle must spend considerable time and effort removing accumulated ice or snow so that the owner can utilize the vehicle. Removing debris from the vehicle can be labor intensive and frustrating.

Some people choose to use conventional vehicle covers or tarps for protecting their vehicle from accumulation of precipitation or debris. However, conventional vehicle covers can be difficult to properly position on a vehicle and may move out of position, particularly in windy conditions. Such vehicle covers lack means for securing the vehicle cover to the vehicle in the desired position. Thus, a vehicle cover having means for securing the vehicle cover to the vehicle is desired.

Devices have been disclosed in the prior art that relate to vehicle coverings. These include devices that have been patented and published in patent application publications. These devices generally relate to protective vehicle coverings having means for securement to the vehicle, such as U.S. Pat. No. 5,971,469, U.S. Published Patent Application Number 2012/0285588, U.S. Published Patent Application Number 2013/0300149, U.S. Pat. No. 3,367,347, and U.S. Pat. No. 5,758,922.

These prior art devices have several known drawbacks. The devices in the prior art relate to vehicle covers, but fail to provide vehicle covers for preventing the accumulation of precipitation or debris on a vehicle's windshields or windows. Such devices disclose various securement means for attachment to a vehicle, but fail to disclose the use of flaps that can be inserted within the vehicle in order to secure the cover to the vehicle. As a result, various fasteners must be used which can be difficult to secure and which may damage or scratch the vehicle.

In light of the devices disclosed in the prior art, it is submitted that the present invention substantially diverges in design elements from the prior art and consequently it is clear that there is a need in the art for an improvement to existing vehicle cover devices. In this regard the instant invention substantially fulfills these needs.

### SUMMARY OF THE INVENTION

In view of the foregoing disadvantages inherent in the known types of vehicle covers now present in the prior art, the present invention provides a new vehicle cover wherein the same can be utilized for providing convenience for the user when preventing precipitation and debris from accumulating on the windows or windshields of a vehicle.

It is therefore an object of the present invention to provide a new and improved vehicle cover comprising an elongated panel adapted to be positioned on a vehicle so as to cover the roof, windshields, and windows thereof.

It is another object of the present invention to provide a vehicle cover having one or more flaps extending from a lower surface thereof, wherein the flaps can be positioned within the interior of a vehicle by opening a door of the vehicle, inserting the flaps, and then closing the door to secure the flaps in position within the vehicle.

Another object of the present invention is to provide a vehicle cover having one or more fasteners disposed about the perimeter of the lower surface of the elongated panel for securement to the exterior or body of the vehicle.

Yet another object of the present invention is to provide a vehicle cover that is composed of a flexible and waterproof material.

Another object of the present invention is to provide a vehicle cover that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a view of the upper surface of the vehicle cover.

FIG. 1B shows a view of the lower surface of the vehicle cover.

FIG. 2 shows a side view of the vehicle cover as positioned on a vehicle.

FIG. 3 shows a perspective view of the vehicle cover as positioned on a vehicle.

### DETAILED DESCRIPTION OF THE INVENTION

Reference is made herein to the attached drawings. Like reference numerals are used throughout the drawings to depict like or similar elements of the vehicle cover. For the purposes of presenting a brief and clear description of the present invention, the preferred embodiment will be discussed as used for preventing precipitation and debris from accumulating on a vehicle and for inhibiting heating of the interior of the vehicle when the vehicle is outside during periods of warm weather. The figures are intended for representative purposes only and should not be considered to be limiting in any respect.

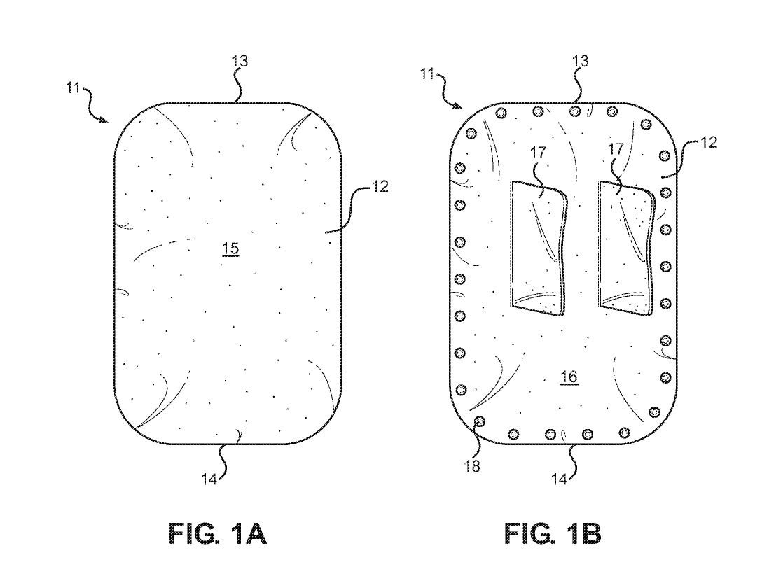

Referring now to FIGS. 1A and 1B, there are shown views of the upper surface and lower surface of the vehicle cover, respectively. The vehicle cover 11 comprises an elongated panel 12 having a front end 13 and a rear end 14. The vehicle cover 11 is substantially rectangular in configuration, however, in alternate embodiments the vehicle cover 11 comprises alternate configurations. In a preferred embodiment, the vehicle cover 11 is sized and shaped so as to cover the roof, front and rear windshields, and the windows of a vehicle. The vehicle cover 11 is preferably composed of a durable and flexible material that can fit to the contours of vehicles of various shapes and sizes. Further, the vehicle cover 11 is preferably composed of a waterproof material so that precipitation and other liquid cannot pass through the vehicle cover 11. In some embodiments, the elongated panel 12 comprises a multi-layer construction and includes one or more layers of insulating material so as to prevent the interior of a vehicle from heating when the vehicle is outdoors in periods of warm weather.

The lower surface 16 of the elongated panel 12 comprises one or more flaps 17 extending therefrom. Preferably, the elongated panel 12 comprises a pair of flaps 17 positioned near the front end 13 of the elongated panel 12. The flaps 17 are preferably substantially the same size and shape. The flaps 17 are separated by a space so that a first flap can be positioned on a first side of the vehicle, and a second flap can be positioned on the second side of a vehicle opposite said first side. The flaps are adapted to be positioned within the interior of a vehicle in order to secure the vehicle cover 11 in position on the vehicle. The flaps 17 are positioned inward from the edges or perimeter of the elongated panel 12 so that a portion of the elongated panel 12 extends over the windows of the vehicle when the flaps 17 are positioned on the interior of the vehicle.

In some embodiments, the lower surface 16 further comprises one or more fasteners 18 thereon adapted to secure the elongated panel 12 to the exterior of a vehicle. The fasteners 18 are preferably positioned about the perimeter or periphery of the elongated panel 12 so as to help the elongated panel 12 remain in a desired position once placed on the vehicle. Any of various suitable fasteners can be used, such as magnetic fasteners, among others.

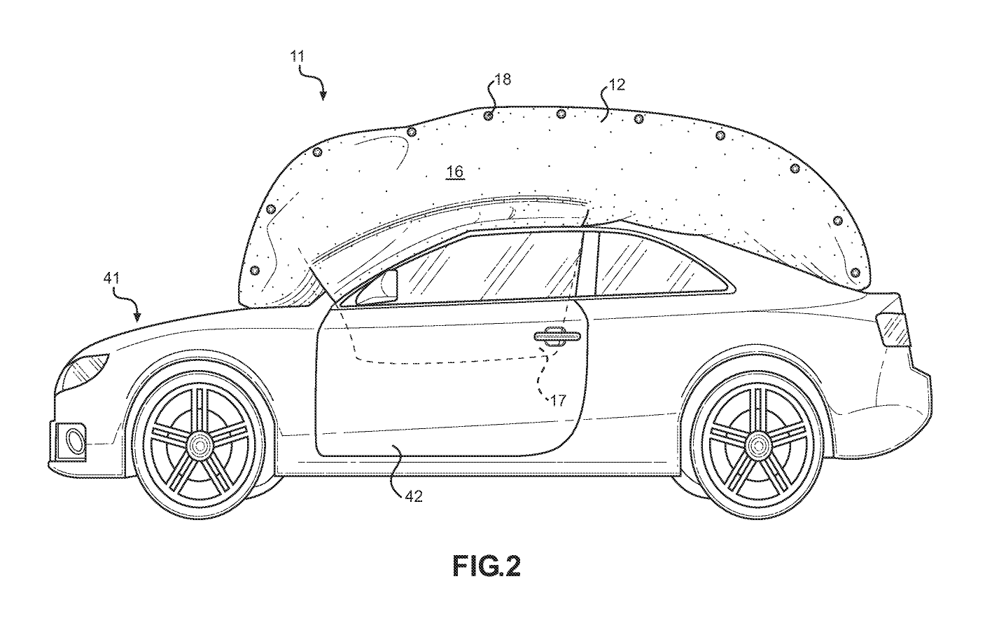

Referring now to FIG. 2, there is shown a side view of the vehicle cover as positioned on a vehicle. In operation, the vehicle cover 11 can be positioned on the roof of the vehicle 41 such that the elongated panel 12 covers the windshields and windows of the vehicle 41. In order to secure the vehicle cover 11 to the vehicle 41, the user can open a door 42 of the vehicle 41, insert a flap 17 on the lower surface 16 of the elongated panel 12 into the interior of the vehicle 41, and shut the door 42 so as to secure the flap 17 within the vehicle 41. In this way, the vehicle cover 11 is secured to the vehicle 41 and cannot be removed therefrom without reopening the door 42 so as to allow the flap 17 to be removed therefrom. In a preferred embodiment, the vehicle cover 11 includes a pair of flaps 17 wherein a first flap is inserted into a first side of the vehicle 41, such as the driver's side, and a second flap is inserted into a second side of the vehicle 41, such as the passenger's side. In this way, the vehicle cover 11 is more securely connected to the vehicle and will remain in position on the vehicle 41.

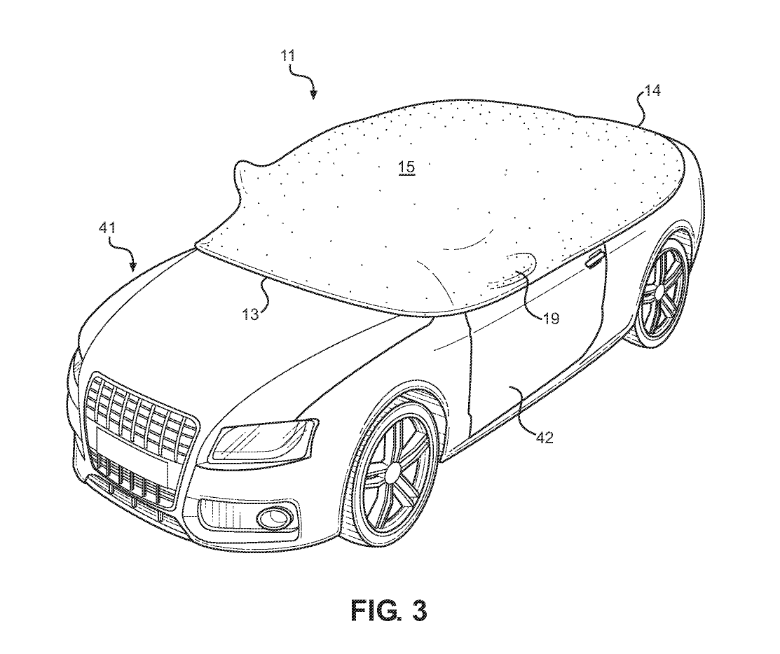

Referring now to FIG. 3, there is shown a perspective view of the vehicle cover as positioned on a vehicle. The elongated panel 12 is sized and shaped so as to cover the windshields and windows of the vehicle so as to prevent the accumulation of precipitation or debris thereon. The elongated panel 12 is composed of a flexible material that fits to the contours of the vehicle. In alternate embodiments, the elongated panel 12 substantially covers the body of the vehicle 41 including the hood, trunk, and doors 42 thereof.

In some embodiments, the vehicle cover 11 further includes one or more pockets 19 thereon. Each pocket 19 is adapted to receive a side view mirror of the vehicle 41 so as to cover the same and prevent the accumulation of precipitation or debris thereon. Thus, the pockets 19 are positioned towards the front end 13 of the elongated panel 12 and extend outward therefrom. Preferably, the elongated panel 12 includes a pair of pockets 19 adapted to receive the pair of side view mirrors of conventional vehicles 41.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle cover, comprising:
an elongated panel having an upper surface and a lower surface, wherein said elongated panel is adapted to be disposed on an exterior of a vehicle;
said elongated panel having one or more flaps extending from an underside thereof, wherein said flaps are adapted to be removably positioned within said vehicle.

2) The vehicle cover of claim 1, wherein said elongated panel comprises a substantially rectangular shape.

3) The vehicle cover of claim 1, wherein said elongated panel is composed of a flexible material.

4) The vehicle cover of claim 1, wherein said elongated panel is composed of a waterproof material.

5) The vehicle cover of claim 1, wherein said one or more flaps are adapted to be positioned within said vehicle and secured via closing a door of said vehicle on said one or more flaps.

6) The vehicle cover of claim 1, wherein said lower surface of said elongated panel comprises one or more fasteners thereon, wherein said one or more fasteners are adapted to be secured to said exterior of said vehicle.

7) The vehicle cover of claim 6, wherein said one or more fasteners are positioned on the perimeter of said elongated panel.

8) The vehicle cover of claim 6, wherein said one or more fasteners are magnets.

9) The vehicle cover of claim 1, further comprising at least one pocket adapted to receive a side view mirror of said vehicle therein.
